(19) United States
(12) Patent Application Publication
(10) Pub. No.: US 2025/0387300 A1
(43) Pub. Date: Dec. 25, 2025

(54) Closed System Vial Adaptor

(71) Applicant: Becton, Dickinson and Company, Franklin Lakes, NJ (US)

(72) Inventors: Say Kiong Toh, Singapore (SG); Mum Pew Ng, Singapore (SG)

(21) Appl. No.: 18/751,918

(22) Filed: Jun. 24, 2024

(51) Int. Cl. A61J 1/20; A61J 1/14

(52) U.S. Cl. CPC A61J 1/2096; A61J 1/201; A61J 1/1406

(57) ABSTRACT

A vial adapter, including a body with a first end, a second end opposite the first end, and a lumen therein, wherein the second end is configured to attach to a container; a membrane adjacent the first end of the body sealing at least a portion of the lumen; and a piercing member extending from the body, the piercing member including: a fluid channel therein in fluid communication with the lumen, a concave end wall at an axial end of the fluid channel, and a sidewall with a plurality of fluid ports therein in fluid communication with the fluid channel.

### BACKGROUND OF THE INVENTION

### Field of the Invention

The present disclosure relates generally to devices and methods of use thereof for the closed transfer of fluids.

### Description of the Related Art

Reconstituting, transporting, and administering hazardous drugs, such as cancer treatments, can put health care providers at risk of exposure to these medications and present a major hazard in the health care environment. For example, nurses treating cancer patients risk being exposed to chemotherapy drugs and their toxic effects when administering these potentially harmful drugs due to insecure connections or inadvertent disconnection of the delivery devices or adapters used to transport or administer such drugs. Unintentional chemotherapy exposure can affect the nervous system, impair the reproductive system, and bring an increased risk of developing blood cancers in the future. The present disclosure provides improved systems, components, and methods of use thereof to reduce the risk of health care providers being exposed to toxic drugs during dilution, reconstitution, and/or transfer.

### SUMMARY OF THE INVENTION

In accordance with one aspect, the present disclosure is directed to a vial adapter, including a body with a first end, a second end opposite the first end, and a lumen therein, wherein the second end is configured to attach to a container; a membrane adjacent the first end of the body sealing at least a portion of the lumen; and a piercing member extending from the body, the piercing member including: a fluid channel therein in fluid communication with the lumen, a concave end wall at an axial end of the fluid channel, and a sidewall with a plurality of fluid ports therein in fluid communication with the fluid channel.

In some non-limiting embodiments or aspects, the piercing member may include a closed end tip.

In some non-limiting embodiments or aspects, the piercing member may have a symmetrical longitudinal cross-sectional shape.

In some non-limiting embodiments or aspects, the piercing member may have a conical longitudinal cross-sectional shape.

In some non-limiting embodiments or aspects, the plurality of fluid ports may include two fluid ports radially spaced from each other.

In some non-limiting embodiments or aspects, each of the plurality of fluid ports may define a longitudinal axis at a non-parallel angle with respect to a longitudinal axis of the lumen.

In some non-limiting embodiments or aspects, the concave end wall may be axially positioned between the second end and the plurality of fluid ports.

In some non-limiting embodiments or aspects, the adapter may include a plurality of vial attachment elements extending from the body and configured to fasten the body to the container.

In some non-limiting embodiments or aspects, the body may include a base and an elongated segment extending from the base, wherein the elongated segment may define the first end of the body.

In some non-limiting embodiments or aspects, the adapter may include a plurality of retention elements extending from the elongated segment and configured to engage a syringe adapter.

In some non-limiting embodiments or aspects, the concave end wall may define a radius of curvature between 0.2 mm and 0.4 mm.

In some non-limiting embodiments or aspects, the concave end wall may define a first sidewall and a second sidewall, and the second sidewall may form an angle with the first sidewall between 80 degrees and 100 degrees.

In accordance with one aspect, the present disclosure is directed to a system for transferring fluids, comprising: a syringe adapter comprising: a housing defining a first end, a second end, and a longitudinal axis extending from the fist end to the second end; a cannula positioned within the housing; and a seal arrangement movably positioned within the housing; and a vial adapter releasably attachable to the syringe adapter, the vial adapter comprising: a body with a first end, a second end opposite the first end, and a lumen therein, wherein the first end is positionable within the housing of the syringe adapter and the second end is configured to attach to a container; and a piercing member extending from the body, the piercing member including: a fluid channel therein in fluid communication with the lumen, a concave end wall at an axial end of the fluid channel, and a sidewall with a plurality of fluid ports therein in fluid communication with the fluid channel

In some non-limiting embodiments or aspects, the piercing member may include a closed end tip.

In some non-limiting embodiments or aspects, the piercing member may have a symmetrical longitudinal cross-sectional shape.

In some non-limiting embodiments or aspects, the piercing member may have a conical longitudinal cross-sectional shape.

In some non-limiting embodiments or aspects, the plurality of fluid ports may include two fluid ports radially spaced from each other.

In some non-limiting embodiments or aspects, each of the plurality of fluid ports may define a longitudinal axis at a non-parallel angle with respect to a longitudinal axis of the lumen.

In some non-limiting embodiments or aspects, the vial adapter may include a membrane sealing at least a portion of the lumen, and the membrane may be positionable adjacent the seal arrangement of the syringe adapter when the first end of the vial adapter is positioned within the housing of the syringe adapter.

In some non-limiting embodiments or aspects, at least a portion of the cannula may be positioned within the lumen when the membrane is positioned adjacent the seal arrangement of the syringe adapter.

Further examples of the present disclosure will now be described in the following numbered clauses.

Clause 1: A vial adapter, comprising: a body with a first end, a second end opposite the first end, and a lumen therein, wherein the second end is configured to attach to a container; a membrane adjacent the first end of the body sealing at least a portion of the lumen; and a piercing member extending from the body, the piercing member including: a fluid channel therein in fluid communication with the lumen, a concave end wall at an axial end of the fluid channel, and a sidewall with a plurality of fluid ports therein in fluid communication with the fluid channel.

Clause 2: The vial adapter of clause 1, wherein the piercing member includes a closed end tip.

Clause 3: The vial adapter of clause 1 or clause 2, wherein the piercing member has a symmetrical longitudinal cross-sectional shape.

Clause 4: The vial adapter of any of clauses 1-3, wherein the piercing member has a conical longitudinal cross-sectional shape.

Clause 5: The vial adapter of any of clauses 1-4, wherein the plurality of fluid ports includes two fluid ports radially spaced from each other.

Clause 6: The vial adapter of any of clauses 1-5, wherein each of the plurality of fluid ports defines a longitudinal axis at a non-parallel angle with respect to a longitudinal axis of the lumen.

Clause 7: The vial adapter of any of clauses 1-6, wherein the concave end wall is axially positioned between the second end and the plurality of fluid ports.

Clause 8: The vial adapter of any of clauses 1-7, further comprising a plurality of vial attachment elements extending from the body and configured to fasten the body to the container.

Clause 9: The vial adapter of any of clauses 1-8, wherein the body includes a base and an elongated segment extending from the base, wherein the elongated segment defines the first end of the body.

Clause 10: The vial adapter of clause 9, further comprising a plurality of retention elements extending from the elongated segment and configured to engage a syringe adapter.

Clause 11: The vial adapter of any of clauses 1-10, wherein the concave end wall defines a radius of curvature between 0.2 mm and 0.4 mm.

Clause 12: The vial adapter of any of clauses 1-11, wherein the concave end wall defines a first sidewall and a second sidewall, and wherein the second sidewall forms an angle with the first sidewall between 80 degrees and 100 degrees.

Clause 13: A system for transferring fluids, comprising: a syringe adapter comprising: a housing defining a first end, a second end, and a longitudinal axis extending from the fist end to the second end; a cannula positioned within the housing; and a seal arrangement movably positioned within the housing; and a vial adapter releasably attachable to the syringe adapter, the vial adapter comprising: a body with a first end, a second end opposite the first end, and a lumen therein, wherein the first end is positionable within the housing of the syringe adapter and the second end is configured to attach to a container; and a piercing member extending from the body, the piercing member including: a fluid channel therein in fluid communication with the lumen, a concave end wall at an axial end of the fluid channel, and a sidewall with a plurality of fluid ports therein in fluid communication with the fluid channel

Clause 14: The system of clause 13, wherein the piercing member includes a closed end tip.

Clause 15: The system of clause 13 or clause 14, wherein the piercing member has a symmetrical longitudinal cross-sectional shape.

Clause 16: The system of clause 15, wherein the piercing member has a conical longitudinal cross-sectional shape.

Clause 17: The system of any of clauses 13-16, wherein the plurality of fluid ports includes two fluid ports radially spaced from each other.

Clause 18: The system of any of clauses 13-17, wherein each of the plurality of fluid ports defines a longitudinal axis at a non-parallel angle with respect to a longitudinal axis of the lumen.

Clause 19: The system of any of clauses 13-18, wherein the vial adapter further comprises a membrane sealing at least a portion of the lumen, and wherein the membrane is positionable adjacent the seal arrangement of the syringe adapter when the first end of the vial adapter is positioned within the housing of the syringe adapter.

Clause 20: The system of clause 19, wherein at least a portion of the cannula is positioned within the lumen when the membrane is positioned adjacent the seal arrangement of the syringe adapter.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a perspective view of an example of a closed fluid transfer system constructed in accordance with the principles of the present invention.

FIG. 2 is a perspective view of an example of a syringe adapter constructed in accordance with the principles of the present invention.

FIG. 3 is a cross-sectional view of the syringe adapter of FIG. 2.

FIG. 4 is a perspective view of an example of a vial adapter constructed in accordance with the principles of the present invention.

FIG. 5 is a cross-sectional view of the vial adapter of FIG. 4.

FIG. 6 is an additional cross-sectional view of the vial adapter of FIG. 4.

FIG. 7A is an enlarged partial view of the vial adapter of FIG. 6.

FIG. 7B is a partial cross-sectional view of the vial adapter of FIG. 6.

FIG. 7C is an enlarged partial side view of the vial adapter of FIG. 6.

FIG. 8 is a side view of an example of bifurcated fluid flow resulting from use of an example of a vial adapter constructed in accordance with the principles of the present invention.

FIG. 9 is a cross-sectional view of assembled components of the system of FIG. 1.

FIG. 10 is an illustration of an example of use of the system of FIG. 1.

### DETAILED DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the concept as it is oriented in the drawing figures. However, it is to be understood that the concept may assume various alternative variations, except where expressly specified to the contrary. It is also to be understood that the specific devices illustrated in the attached drawings, and described in the following specification, are simply exemplary embodiments of the concept. Hence, specific dimensions and other physical characteristics related to the embodiments disclosed herein are not to be considered as limiting.

The word “comprising” and “comprises”, and the like, does not exclude the presence of elements or steps other than those listed in any claim or the specification as a whole. In the present specification, “comprises” means “includes” and “comprising” means “including.”

As used herein, “at least one of” is synonymous with “one or more of.” For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “at least” is synonymous with “greater than or equal to.” The terms “first”, “second”, and the like are not intended to refer to any particular order or chronology, but refer to different conditions, properties, or elements. As used herein, the singular form of “a”, “an”, and “the” include plural referents unless the context clearly dictates otherwise.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

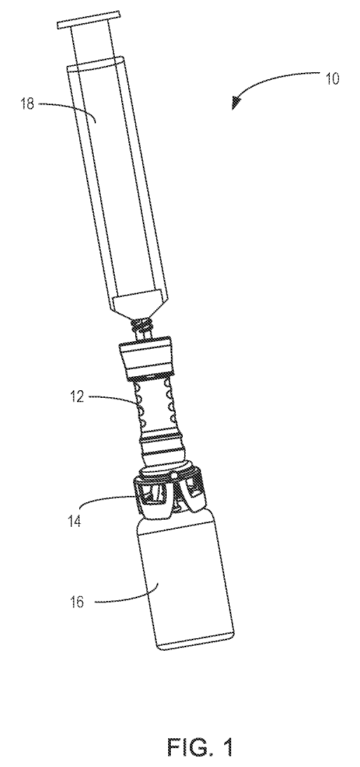

Referring now to FIG. 1 in which like reference designations refer to like elements, an example of a closed fluid transfer system 10 generally including a syringe adapter 12 and a vial adapter 14 operable to securely transfer fluids is shown. The system 10 provides substantially leak-proof sealing during transfer of a fluid to and/or from a first container 16, such as a vial, to a second container 18, such as a syringe, IV bag, patient IV line, or other container. Although not shown, the system 10 may further include one or more of an IV bag adapter as well as other components typically utilized in closed system transfer devices, such as infusion lines and/or extension sets.

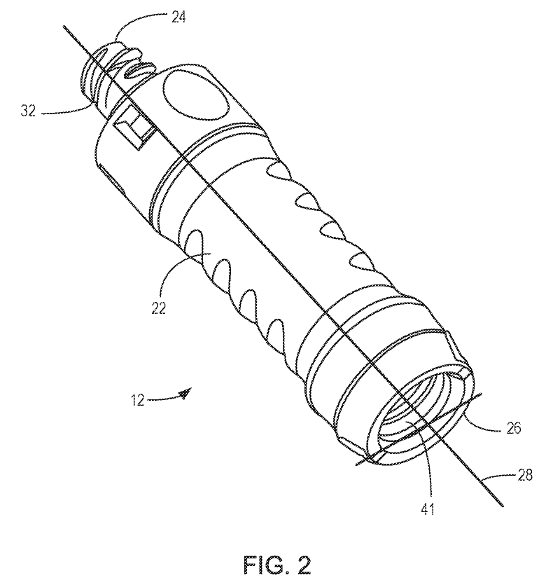

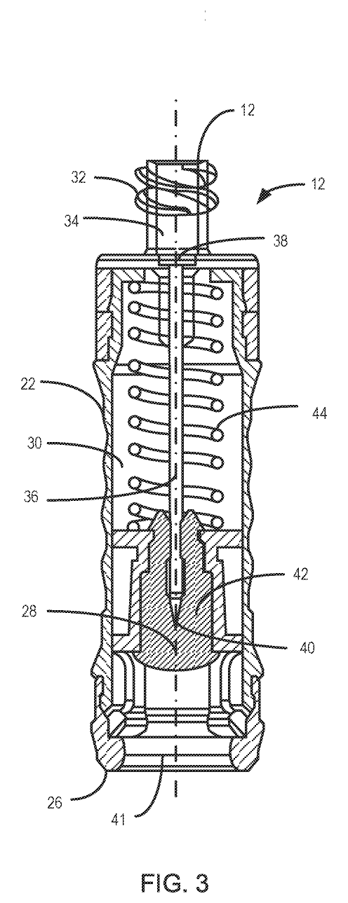

Referring to FIGS. 2 and 3, an example of the syringe adapter 12 is illustrated. The syringe adapter 12 is configured to receive at least a portion of the vial adapter 14 therein, and is further configured to connect to the syringe 18 or other medical device or fluid container. The medical device can be, for example, a patient line, vial adapter, fluid container, or infusion adapter. The syringe adapter 12 can be used to facilitate the closed transfer of fluids between the container 16, through the vial adapter 14, and into the syringe or fluid container 18. The syringe adapter 12 is similar to and operates in a similar manner as the adapter shown and described in United States Patent No. 10,744,315, which is hereby incorporated by reference in its entirety.

The syringe adapter 12 includes a housing 22 having a first end 24, a second end 26, and a longitudinal axis 28 extending therebetween. The longitudinal axis 28 extends through each of the vial adapter 14, first container 16, and second container 18 in a coaxially assembled configuration of the system 10, and provides a longitudinal reference for each such component individually as referenced herein. The housing 22 defines or includes an interior cavity 30. The first end 24 of the housing 22 of the adapter 12 may include a syringe or device attachment feature 32, such as a female luer connector, that defines a passageway 34. Although a female luer connector is shown for connection with a corresponding male luer connector of a syringe (not shown), other suitable connection arrangements may be utilized for connection to a syringe, container, or any other medical device. A cannula 36 is secured to the housing 22 and defines a proximal end 38 adjacent to or otherwise in fluid communication with the passageway 34, and the cannula 36 defines or includes a distal end 40 within the cavity 30 of the housing 22 extending in the direction of the second end 26. The syringe adapter 12 defines or includes an opening 41 at the second end 26 that is sized and shaped to receive at least a portion of the vial adapter 14 therethrough.

The adapter 12 further includes a seal arrangement 42 positioned within the housing 22 and configured to move within the interior cavity 30 in an axial direction along the longitudinal axis 28. The seal arrangement 42 may include one or more collets or other structural framing components and/or one or more membranes, barriers, or other fluid impermeable features to prevent or substantially reduce fluid flow through the distal end 40 of the cannula 36 until the adapter 12 is coupled to the vial adapter 14 and/or is otherwise prepared for fluid transport.

The adapter 12 may include a drive member 44 that biases the axially-movable seal arrangement 42 towards a first position adjacent to or in proximity to the second end 26 of the housing 22. The drive member 44 may include a spring or other biasing means configured to provide the features described herein. Upon an application of an axial force, the biasing of the drive member 44 is overcome, and the seal arrangement 42 can be moved axially in a direction towards the first end 24 of the housing 22, such that the distal end 40 of the cannula 36 pierces or otherwise passes through the seal arrangement 42, as described further herein. Upon disengagement or release of the axial force against the drive member 44, the seal arraignment 42 is biased back to its original position towards the second end 26 of the housing 22, thereby positioning the distal end 40 of the cannula 36 within or proximal to the seal arrangement 42. Such an arrangement shields the distal end 40 of the cannula 36 to prevent accidental needle sticks and also prevents the leakage of any fluid during transfer of fluids when using the syringe adapter 12.

The syringe adapter 12 may include or define one or more features to releasably and securely engage the vial adapter 14 to prevent or significantly reduce the likelihood that the syringe adapter 12 shifts, rotates along an axis oblique to the longitudinal axis 28, or otherwise moves such that leakage could occur along the fluid path between the syringe adapter 12 and the vial adapter 14 when assembled together.

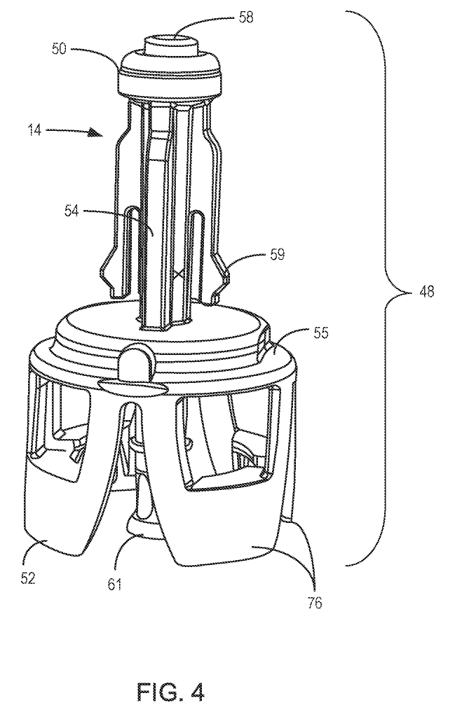

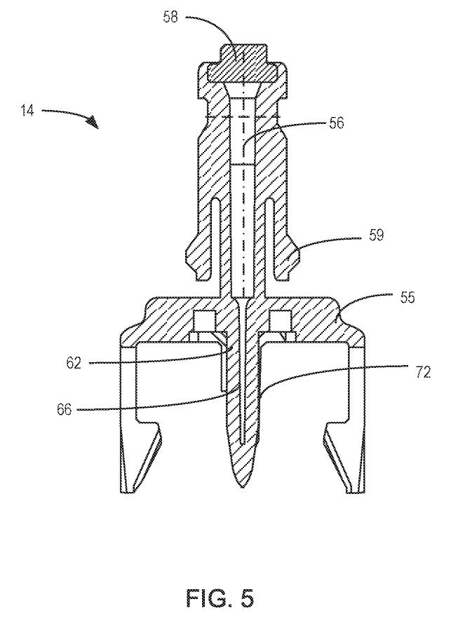

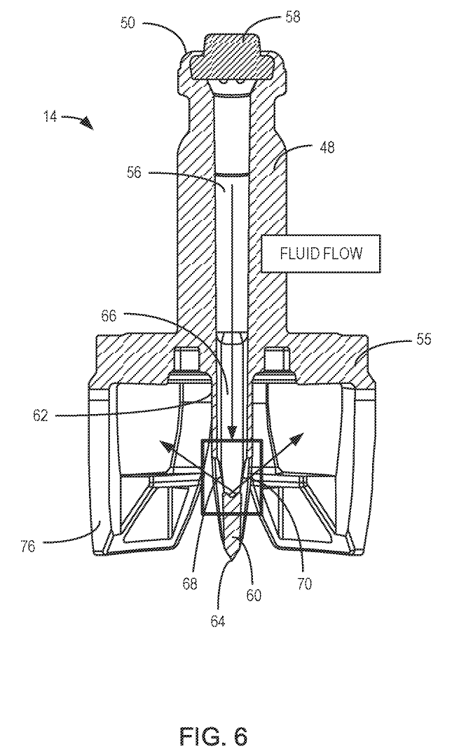

Referring now to FIGS. 4-7C, the vial adapter 14 includes a body 48 having a first end 50 and a second end 52. The first end 50 is configured to engage with or otherwise be assembled with the second end 26 and/or interior cavity 30 of the syringe adapter 12. The body 48 of the vial adapter 14 may include an elongated segment 54 that extends to and/or defines the first end 50, where the segment 54 defines or includes a lumen 56 therein extending substantially parallel to the longitudinal axis 28. The elongated segment 54 may have a narrower or smaller diameter or width compared to a base or flange component 55 constituting a middle or intermediate segment between the first and second ends 50, 52 of the body 48. The vial adapter 14 may include a membrane 58 at or adjacent to the first end 50 of the vial adapter 14. The membrane 58 seals the lumen 56 at or near the first end 50 of the vial adapter 14 until pierced for secure transfer of fluids as described further herein. The membrane 58 may include one or segments of fluid impermeable material, layers, coatings or otherwise to prevent or substantially reduce fluid flow through the lumen 56 at the first end 50. The first end 50 of the vial adapter 14 is positionable through the opening 41 in the second end 26 of the housing 22 of the syringe adapter 14 such that at least a portion of the vial adapter 14 is positioned within the interior cavity 30 of the housing 22. The vial adapter 14 may be positioned within the housing 22 such that the membrane 58 of the vial adapter 14 abuts or is otherwise adjacent to the seal arrangement 42 of the adapter 12.

The vial adapter 14 may define or include one or more features to engage the syringe adapter 12. The engagement between the vial adapter and syringe adapter may be releasable, and/or provide axial and/or rotational interlocking during fluid transfer to reduce or prevent leaks. For example, the vial adapter 14 may include or define one or more retention elements 59 on or extending from the body 48 that matably connect with or engage at least a portion of the syringe adapter 12 to provide a secure connection. In one example, each of the one or more retention elements 59 may be mounted on or extend from the elongated segment 54 of the body 48 of the vial adapter 14 and constitute a depressible and/or cantilevered tab, bracket, catch, or other structure sized and shaped to engage the syringe adapter 12. In the illustrated embodiment, there are two retention elements 59 radially spaced equidistant (e.g., at 180 degrees apart) around the elongated segment 54 of the body 48 of the vial adapter.

The second end 52 of the vial adapter 14 may include a piercing member 60 that is configured to pierce a cap, lid or other seal of the first container 16. A removable cap or sleeve 61 may be positioned over the piercing member 60 during storage and/or transport, as shown in FIG. 4. The piercing member 30 may generally include or define a first end 62 proximate, adjacent, coupled to, and/or otherwise extending from the base 55. The piercing member 30 may generally include or define a second end 64 opposite the first end 62 that includes or defines a tip sized and shaped to facilitate piercing the first container 16. The second end 64 may include, for example, a tapered or reduced diameter terminating at the tip, a conical shape, or other configuration providing the functions and features described herein. The second end 64 may have a substantially symmetrical shape or profile to facilitate ease of piercing and to reduce the force needed to insert the piercing member 60 into a vial or container. The second end 64 may be closed, sealed, or otherwise devoid of any opening to avoid coring, fragmentation, and/or otherwise obstructing fluid flow through the piercing member 60 as described herein.

The piercing member 60 may include or define a fluid channel 66 therein extending along at least a portion of the length from the first end 62 towards or in proximity to the second end 64. The fluid channel 62 may be connected to, contiguous with, and/or otherwise in fluid communication with the lumen 56 extending through the elongated segment 54 of the body 48 of the vial adapter 14. The piercing member 60 may include or define first and second fluid ports 68, 70 in a sidewall 72 that extends between the first end 62 and second end 64 of the piercing member 60. The first and second fluid ports 68, 70 may be longitudinally spaced from the tip of the second end 64 of the piercing member 60 (e.g., located between the tip of the second end 64 and the first end 62), and may be connected to or otherwise provide fluid communication with the fluid channel 66. The first and second fluid ports 68, 70 may be radially spaced or arranged around the circumference or perimeter of the sidewall 72. In one example, the first and second fluid ports 68, 70 may be radially spaced equidistant (e.g., at 180 degrees apart) around the circumference or perimeter of the sidewall 72. In one example, each of the first and second fluid ports 68, 70 may include or define an elongated dimension along a longitudinal axis thereof and/or include a non-non-symmetrical oval shape. In one example, the first and second fluid ports 68, 70 may each taper radially inward along their axial length such that the first and second fluid ports 68, 70 are angled with respect to the longitudinal axis 28.

The piercing member 60 may include or define an interior end wall 74 on an interior thereof that defines or includes an end or terminating surface of the fluid channel 66 near the second end 64 of the piercing member 60. The end wall 74 may generally be oriented transverse or perpendicular to the longitudinal axis 28 and/or a longitudinal axis of the piercing member 60, the elongated segment 54, and/or the fluid channel 66. The end wall 74 may include or define one or more contoured segments or portions. In one example, the end wall 74 may include or define a semi-spherical shape. In one example, the end wall 74 may include or define a concave cross-sectional shape. The concave cross-sectional shape may include or define an apex of curvature 74a centered on or otherwise aligned with the longitudinal axis 28 and/or a longitudinal axis of the piercing member 60, the elongated segment 54, and/or the fluid channel 66, and/or a centerline of any of those features. The concave cross-sectional shape may include or define a radius of curvature R1 sufficient to repel and direct fluid upward and outward as described herein. In some non-limiting examples or aspects, the radius of curvature R1 may be between 0.2 mm and 0.4 mm.

The end wall 74 may include or define sloped or contoured sidewalls 74b, 74c extending away from the center or apex 74a of the end wall. The sidewalls 74b, 74c may be symmetrical about the longitudinal axis 28 of the adapter 14, and may be angled to direct fluid flow upwards and outwards from the fluid ports as described herein. In some non-limiting examples or aspects, the sidewalls 74b, 74c may form an angle θ therebetween that is between 80 degrees and 100 degrees to provide the fluid flow characteristics and benefits described herein.

The contoured surface of the end wall 74 may include or define an axial length L1, as measured between the center or apex 74a and the edges or ends of the sidewall 74b, 74c, sufficient to provide the fluid flow characteristics and benefits described herein. In some non-limiting examples or aspects, the axial length L1 may be between 0.56 mm and 0.76 mm.

In some non-limiting examples or aspects, the axial length L1 may be sized or selected depending upon and/or in relation to a width W1 of the fluid channel 66 to provide the fluid flow characteristics and benefits described herein. In some non-limiting examples or aspects, the width W1 of the fluid channel 66 may be between 2.0 mm and 2.5 mm. The ratio of the width W1 to the axial length L1 may be between 2.6:1 and 4.4:1 to provide the fluid flow characteristics and benefits described herein.

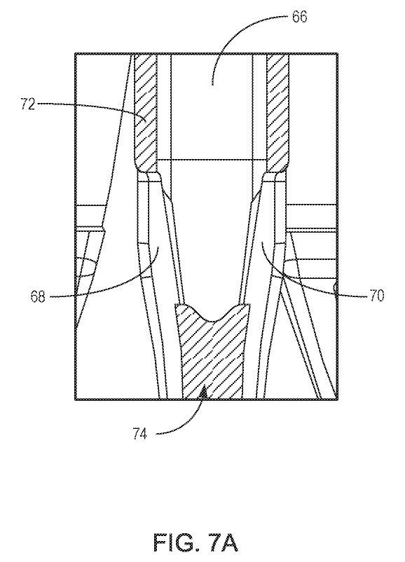

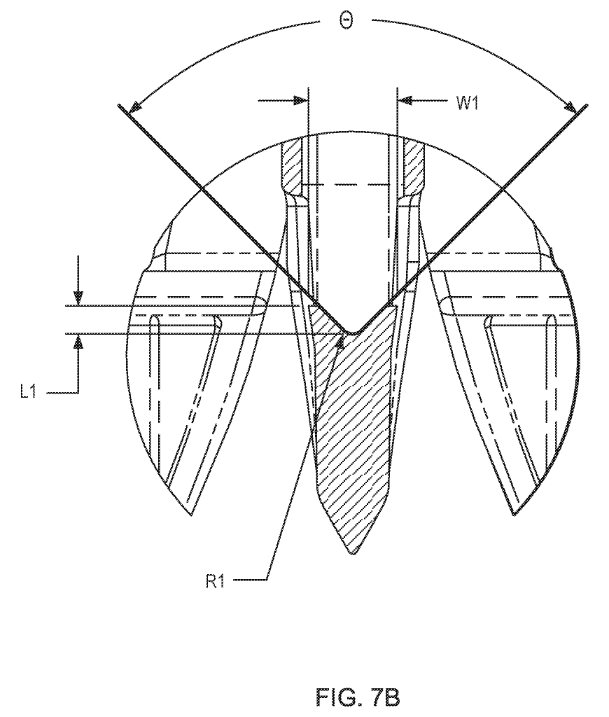

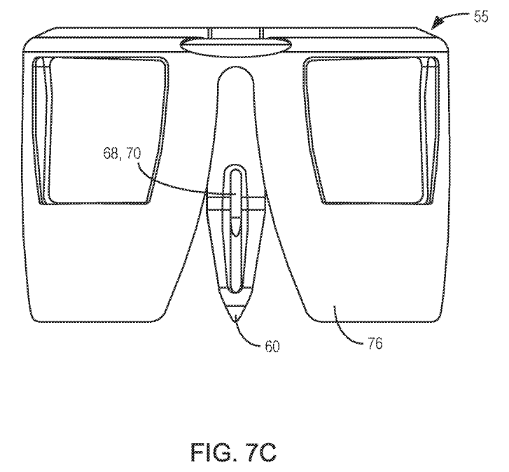

The end wall 74 may include or define a curvature such that at least a portion of the end wall 74 is axially closer to the second end 64 of the piercing member 60 than a bottom or lower end of each of the first and second fluid ports 68, 70. In such a configuration, the end wall 74 has a portion that is axially positioned between the second end 64 of the piercing member 60 and a lower end of each of the first and second fluid ports 68, 70, an example of which is shown in FIG. 7C.

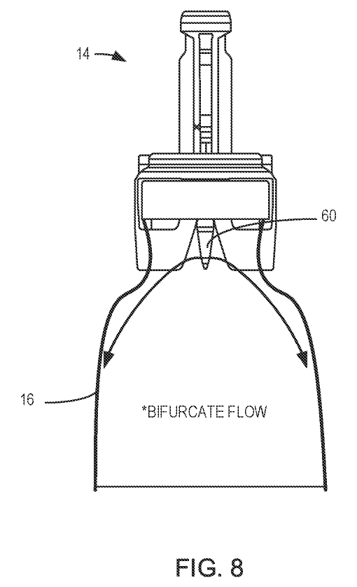

The end wall 74 and the first and second fluid ports 68, 70 are configured to direct fluid partially upward (e.g., towards the first end 62 of the piercing member 60 and/or the base 55) and radially outward relative to the piercing member 60. For example, as illustrated in FIG. 8, fluid flowing in the fluid channel 66 in a direction from the first end 62 of the piercing member 60 to the second end 64 will contact the end wall 74, and be directed partially upwards and out of the first and second fluid ports 68, 70 and towards the sidewall of the interior of the first container 16. In conventional vial adapters, fluid is typically directed downwards directly into the contents of a vial, which can cause foaming and bubbles to form due to the turbulent action of the fluid thereby requiring a waiting period prior to further use of the vial contents. The configuration described herein directs the fluid towards the sidewall of the first container 16, which prevents the liquid from forcefully hitting powdered medication or other compounds and producing disturbed air bubbles that may require additional time to dissipate prior to further use.

The second end or segment 52 of the vial adapter 14 is configured and operable to engage with the first container 16 (such as a vial, jar, or the like) for secure fluid transfer from the container 18, through the vial adapter 14, to the syringe adapter 12, and towards the syringe 18 or other device coupled to the first end 24 of the syringe adapter 12. The second end 52 of the vial adapter 14 may include one or more vial attachment elements 76 to secure the vial adapter 14 to the first container 16, such as a vial or other container. The vial attachment elements 76 may include one or more tabs, snaps or other mechanical components that matably secure the vial adapter 14 to the first container 16 for fluid transfer. The vial attachment elements 76 may be radially spaced around a perimeter or circumference of the base 55 and extend towards or otherwise constitute a portion of the second end 52 of the body 48 of the vial adapter 14.

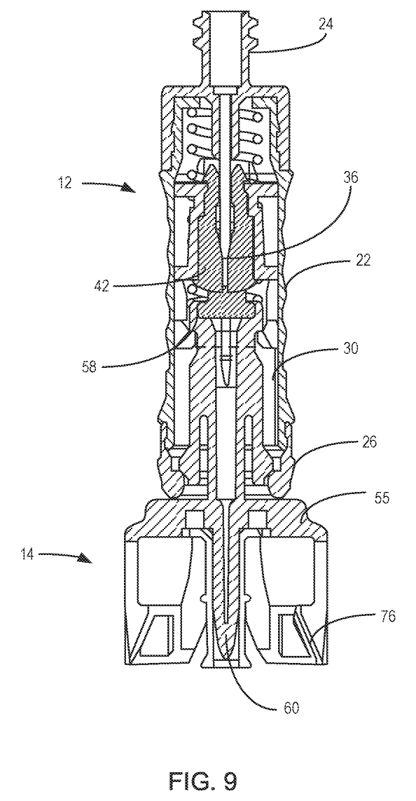

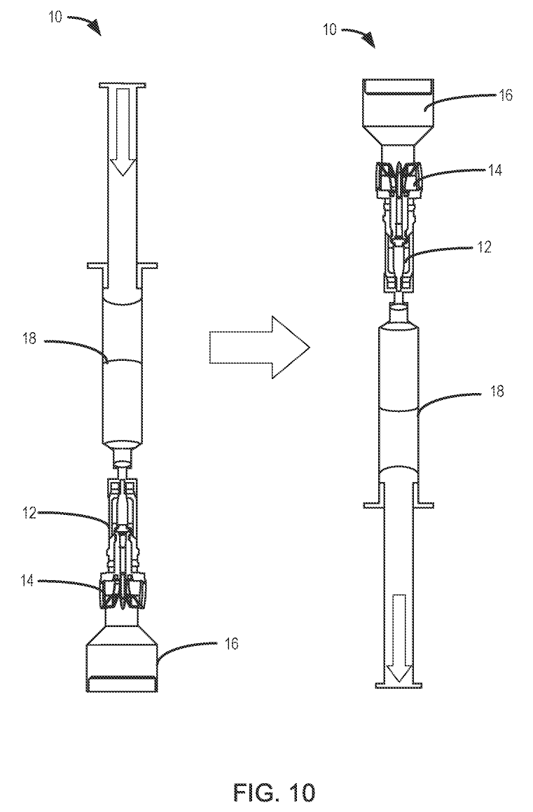

Now referring to FIGS. 9 and 10, in one example of assembly and use, the system 10 may be used to transfer one or more fluids throughout one or more components of the system 10 to mix, dilute, extract, inject, or otherwise prepare a compound or substance. The first container 16 may be secured tom the vial adapter 14 by, for example, the one or more attachment elements 76. Securing the first container 16 to the vial adapter may include piercing a lid, seal, stopper, or otherwise of the first container 16 with the piercing member 60, thereby placing the first and second fluid ports 68, 70 in fluid communication with the interior of the first container 16.

The second container 18 (illustrated as a syringe, for example) may be secured to the syringe adapter 12, and the syringe adapter 12 may be secured to the vial adapter 14. The coaxial insertion and positioning of a portion of the vial adapter 14 within the cavity 30 of the housing 22 axially moves the seal arrangement 42 towards the first end 24 of the syringe adapter 12. Movement of the seal arrangement 42 causes the distal end 40 of the cannula 36 to pierce the seal arrangement 42 and the membrane 58 of the vial adapter 14, resulting in the cannula 36 being at least partially positioned within the lumen 56 of the body 48 of the vial adapter 14. As a result, the assembled syringe adapter 12 and vial adapter 14 provides a fluid flow path from the first container 16 through the fluid channel 66, into the lumen 56, through the cannula 36, out of the first end 24 of the syringe adapter 12, and into the interior of the second container 18. Fluid may then be transferred through this fluid flow path through manipulation of a pressure-inducing element, such as a pump, syringe plunger, or other modality attached to or otherwise in communication with the fluid flow path and/or the second container 18.

Other features and details regarding the devices and methods disclosed herein are provided in United States Patent No. 11,147,958, which is hereby incorporated by reference in its entirety.

It will be appreciated by persons skilled in the art that the present disclosure is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the disclosure. A variety of modifications and variations are possible in light of the above teachings without departing from the scope and spirit of the disclosure, which is limited only by the following claims.

1. A vial adapter, comprising:
a body with a first end, a second end opposite the first end, and a lumen therein, wherein the second end is configured to attach to a container;
a membrane adjacent the first end of the body sealing at least a portion of the lumen; and
a piercing member extending from the body, the piercing member including:
a fluid channel therein in fluid communication with the lumen,
a concave end wall at an axial end of the fluid channel, and
a sidewall with a plurality of fluid ports therein in fluid communication with the fluid channel.

2. The vial adapter of claim 1, wherein the piercing member includes a closed end tip.

3. The vial adapter of claim 1, wherein the piercing member has a symmetrical longitudinal cross-sectional shape.

4. The vial adapter of claim 3, wherein the piercing member has a conical longitudinal cross-sectional shape.

5. The vial adapter of claim 1, wherein the plurality of fluid ports includes two fluid ports radially spaced from each other.

6. The vial adapter of claim 1, wherein each of the plurality of fluid ports defines a longitudinal axis at a non-parallel angle with respect to a longitudinal axis of the lumen.

7. The vial adapter of claim 1, wherein the concave end wall is axially positioned between the second end and the plurality of fluid ports.

8. The vial adapter of claim 1, further comprising a plurality of vial attachment elements extending from the body and configured to fasten the body to the container.

9. The vial adapter of claim 1, wherein the body includes a base and an elongated segment extending from the base, wherein the elongated segment defines the first end of the body.

10. The vial adapter of claim 9, further comprising a plurality of retention elements extending from the elongated segment and configured to engage a syringe adapter.

11. The vial adapter of claim 1, wherein the concave end wall defines a radius of curvature between 0.2 mm and 0.4 mm.

12. The vial adapter of claim 11, wherein the concave end wall defines a first sidewall and a second sidewall, and wherein the second sidewall forms an angle with the first sidewall between 80 degrees and 100 degrees.

13. A system for transferring fluids, comprising:
a syringe adapter comprising:
a housing defining a first end, a second end, and a longitudinal axis extending from the fist end to the second end,
a cannula positioned within the housing, and
a seal arrangement movably positioned within the housing; and
a vial adapter releasably attachable to the syringe adapter, the vial adapter comprising:
a body with a first end, a second end opposite the first end, and a lumen therein, wherein the first end is positionable within the housing of the syringe adapter and the second end is configured to attach to a container, and
a piercing member extending from the body, the piercing member including:
a fluid channel therein in fluid communication with the lumen,
a concave end wall at an axial end of the fluid channel, and
a sidewall with a plurality of fluid ports therein in fluid communication with the fluid channel.

14. The system of claim 13, wherein the piercing member includes a closed end tip.

15. The system of claim 13, wherein the piercing member has a symmetrical longitudinal cross-sectional shape.

16. The system of claim 15, wherein the piercing member has a conical longitudinal cross-sectional shape.

17. The system of claim 13, wherein the plurality of fluid ports includes two fluid ports radially spaced from each other.

18. The system of claim 13, wherein each of the plurality of fluid ports defines a longitudinal axis at a non-parallel angle with respect to a longitudinal axis of the lumen.

19. The system of claim 13, wherein the vial adapter further comprises a membrane sealing at least a portion of the lumen, and wherein the membrane is positionable adjacent the seal arrangement of the syringe adapter when the first end of the vial adapter is positioned within the housing of the syringe adapter.

20. The system of claim 19, wherein at least a portion of the cannula is positioned within the lumen when the membrane is positioned adjacent the seal arrangement of the syringe adapter.
